(19) United States
(12) Patent Application Publication
(10) Pub. No.: US 2004/0022484 A1
(43) Pub. Date: Feb. 5, 2004

(54) Fiber-optic switching element

(76) Inventors: Susanne Sigloch, Mainz (DE); Michel Neumeier, Mandelbachtal (DE); Jens Hossfeld, Rosbach (DE)

Correspondence Address: PEARNE & GORDON LLP, 526 SUPERIOR AVENUE EAST, SUITE 1200, CLEVELAND, OH, 44114-1484, US

(21) Appl. No.: 10/169,526

(22) PCT Filed: Jan. 2, 2001
(86) PCT No.: PCT/EP01/00007

(30) Foreign Application Priority Data
Jan. 7, 2000 (DE) 100 00 483.0

(51) Int. Cl. G02B 6/35

(52) U.S. Cl. 385/22; 385/16

(57) ABSTRACT

A fiber-optic switch uses a fiber-optic switching element in which a moving fiber (1) is positioned by a switching body (2) on a first stop (3) in front of a first fiber (4) which is arranged in a fixed position, or on a second stop (5) in front of a second fiber (6) which is arranged in a fixed position, with the moving fibers (1) being moved with respect to the first or second stop (3, 5) by the switching body (2) for positioning, and being pressed flat against the first or second stop (3, 5).

This invention relates to a fiber-optic switch and to a fiber-optic switch component which comprises one or more fiber-optic switches. In particular, the invention relates to a fiber-optic 1×2 switching element, one or more of which is or are contained in a fiber-optic switch.

In a fiber-optic 1×2 switching element, a moving light guide fiber is generally positioned by means of a switching body either in front of a first light guide fiber which is arranged in a fixed position or in front of a second light guide fiber which is arranged in a fixed position. For the sake of simplicity, a light guide fiber is referred to as a fiber in the following text.

According to GB 2 107 481 A, a moving optical fiber is arranged within a spiral spring, and is positioned by means of a V-shaped groove in front of a first fiber, which is arranged in a fixed position, with there being no load on the spiral spring. The moving optical fiber can be positioned from the rest position in front of the first fiber, which is arranged in a fixed position, in a V-shaped groove in front of a second optical fiber, which is arranged in a fixed position, by means of a switching body which rests on the spiral spring and can be operated, for example, manually. The fibers, which are arranged in fixed positions, do not necessarily rest on one of the V-shaped grooves, but are only aligned with respect to them.

WO88/02869 discloses an optical switch in which a moving fiber is firmly connected to a switching body, by means of which it can be guided with respect to one of two V-shaped stop surfaces, on each of which a fiber which is arranged in a fixed position rests. Mechanical stops are provided in order to limit the movement of the switching body and are arranged such that the optical fibers abut closely against the respective V-shaped stop by virtue of their intrinsic stress.

EP 0 644 447 A1 discloses a mechanical optical switch, in which a movable optical fiber is provided with a magnetic fiber sleeve, in order to position the movable optical fiber in front of a first or a second optical fiber, which are arranged in fixed positions.

As in the optical switches which are disclosed in GB 2 107 481 A and in WO88/02869, and also according to the teaching of EP 0 644 447 A1, the moving optical fiber is guided with respect to a respective stop surface, on which the first and/or second optical fiber or fibers, which is or are arranged in a fixed position or in fixed positions, rests or rest and/or with respect to which the first and/or the second optical fiber or fibers which is or are arranged in a fixed position or fixed positions is or are aligned, with a stop which is used in each case having two positioning surfaces, that is to say two surfaces on which the fibers which are arranged in fixed positions each lie and with respect to which they are aligned, and with respect to which the moving optical fibers are in each case guided.

The optical switches described above require complex drives, collimation optics or precision mechanisms for positioning of the fibers, since the moving fiber is in each case bent toward the stop, on the side facing away from the contact point, with one of the fibers which are arranged in fixed positions, and rests against this stop, in order that the fiber is not bent beyond the deliberate bending and would thus no longer be aligned correctly with respect to the respective fiber arranged in a fixed position. Furthermore, switches such as these are very expensive and/or large due to the comparatively costly coating with magnetic material or the fixed mounting on comparatively costly mechanical actuators. Furthermore, the way that the fibers are grouped in ferrules also results in a considerable space requirement.

The invention is thus based on the object of specifying a fiber-optic switching element, by means of which a fiber-optic switch or a fiber-optic switch component comprising a number of fiber-optic switches can be constructed, which can be produced easily and at low cost.

According to the invention, this object is achieved by a fiber-optic switching element as claimed in patent claim 1. Advantageous developments of the fiber-optic switching element according to the invention are defined in the subsequent patent claims 2 to 11.

A fiber-optic switch and a fiber-optic switch component according to the invention, respectively, are specified in the independent patent claims 12 and 13.

In contrast to the known optical switches described above, the moving fiber according to the invention is not bent toward the stop, that is to say it is not drawn to it, but is moved to the stop and is pressed flat against it. This has the advantage that material characteristics of the fiber, such as its bending stiffness, no longer need to be taken into account in the design, since the adjustment of the moving fiber is carried out on the fiber itself and not—as according to the described prior art—on the switching body, as a result of which, furthermore, there is no need for precise mechanical guides for the switching body, since it now acts only as a driver. In this case, even greater precision is achieved, since the movement is stopped by the fiber itself being stopped on the adjustment structure.

Further advantages of the invention will be explained using the following description of exemplary embodiments of the invention and with reference to the attached drawings, in which:

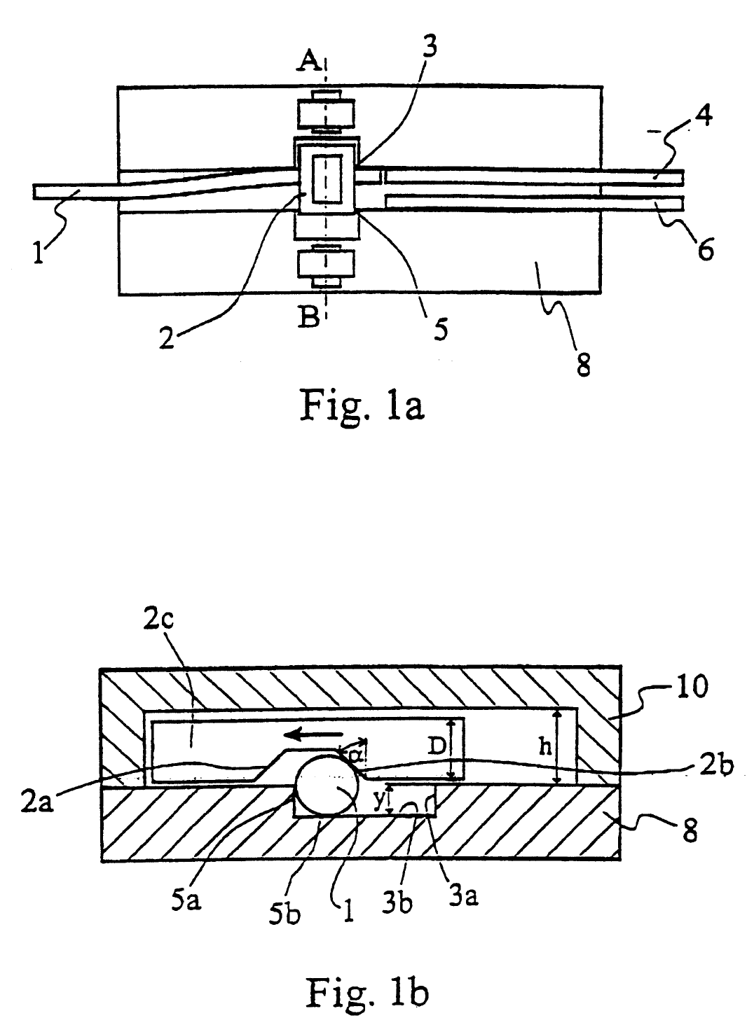

FIG. 1a shows a plan view of a first embodiment of a fiber-optic switching element according to the invention;

FIG. 1b shows a section illustration of the first embodiment according to the invention, as illustrated in FIG. 1a;

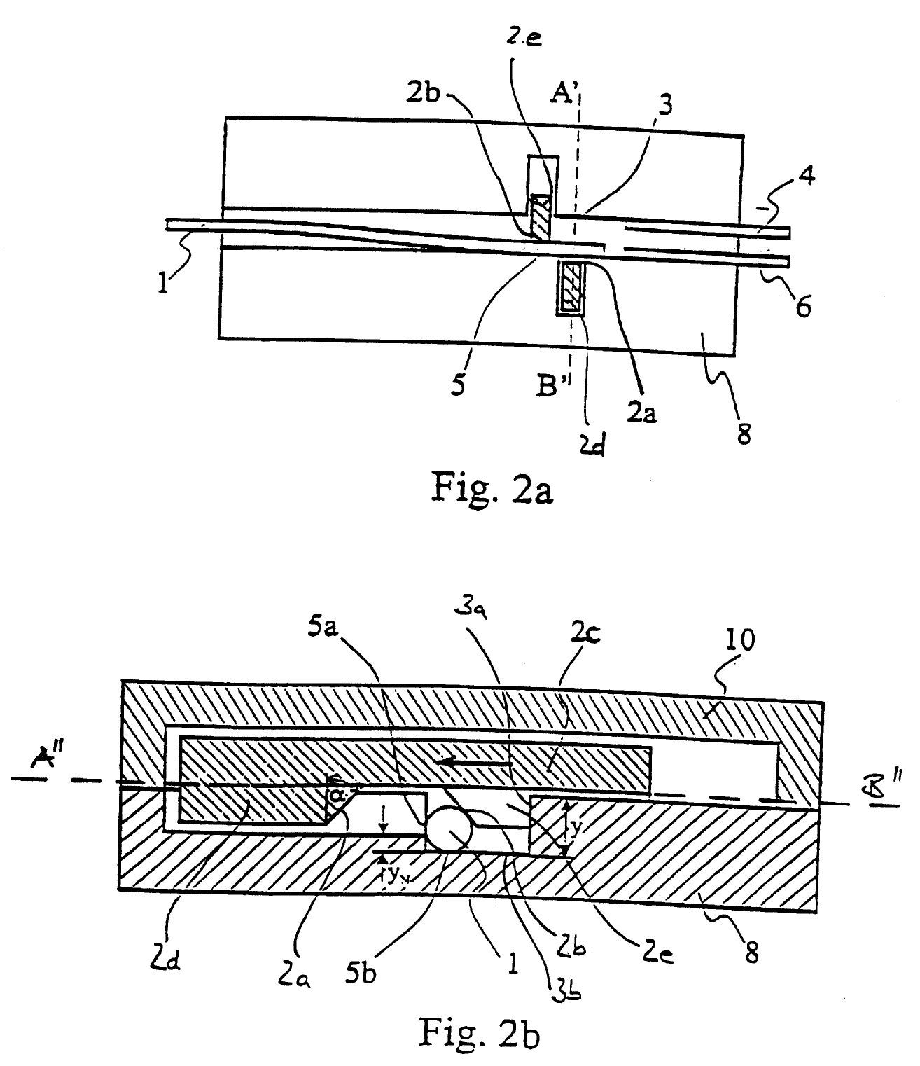

FIG. 2a shows a plan view of a second embodiment of a fiber-optic switching element according to the invention;

FIG. 2b shows a section illustration of the second embodiment according to the invention, as illustrated in FIG. 2a;

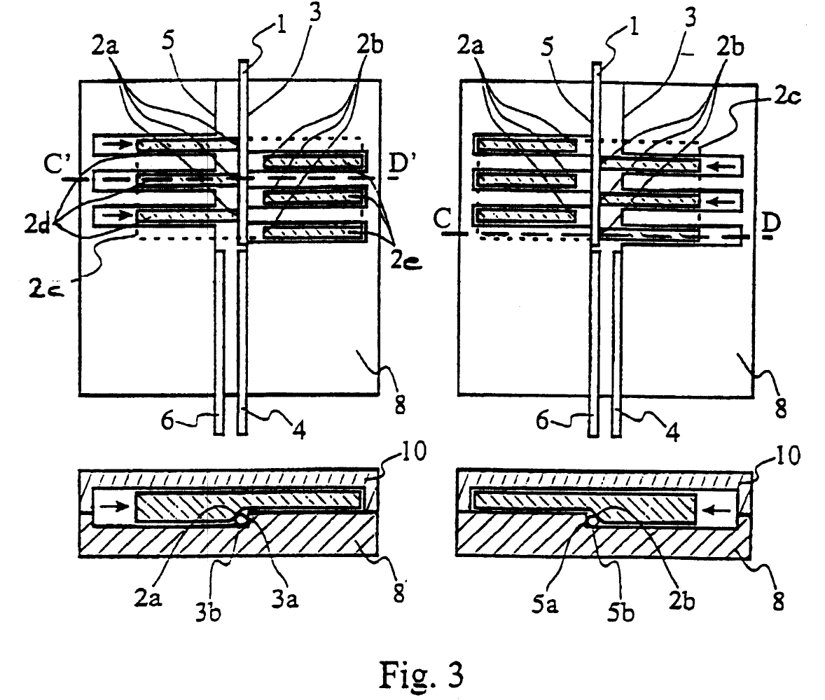

FIG. 3 shows two switching states of a further design variant of the second embodiment according to the invention;

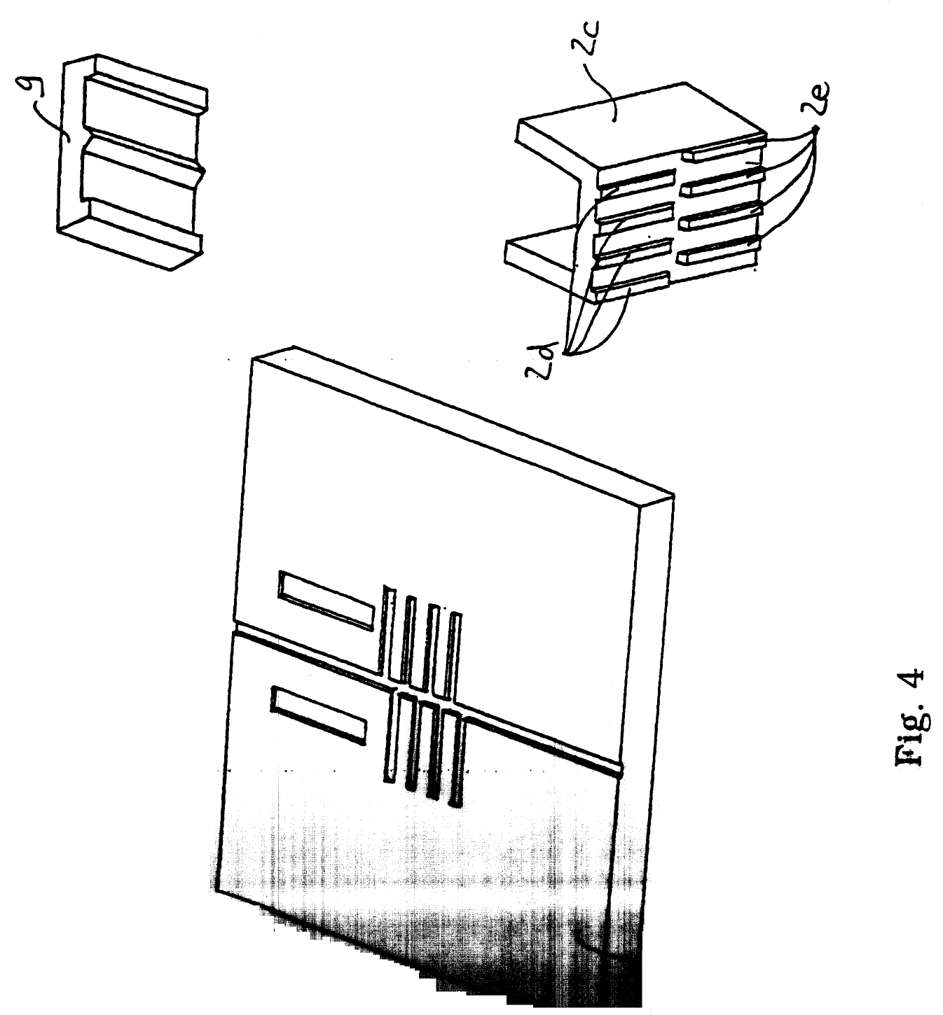

FIG. 4 shows a three-dimensional illustration of the individual parts of a further design variant of the second embodiment according to the invention;

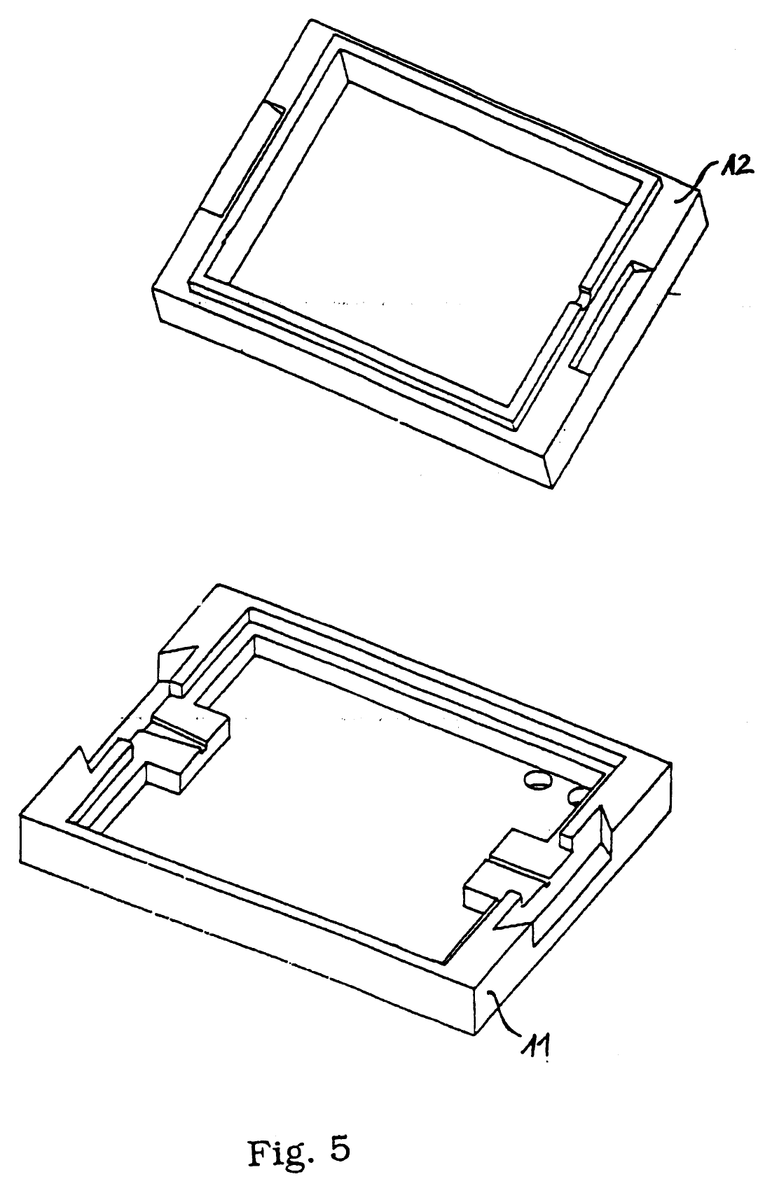

FIG. 5 shows a housing for the switching element shown in FIG. 4;

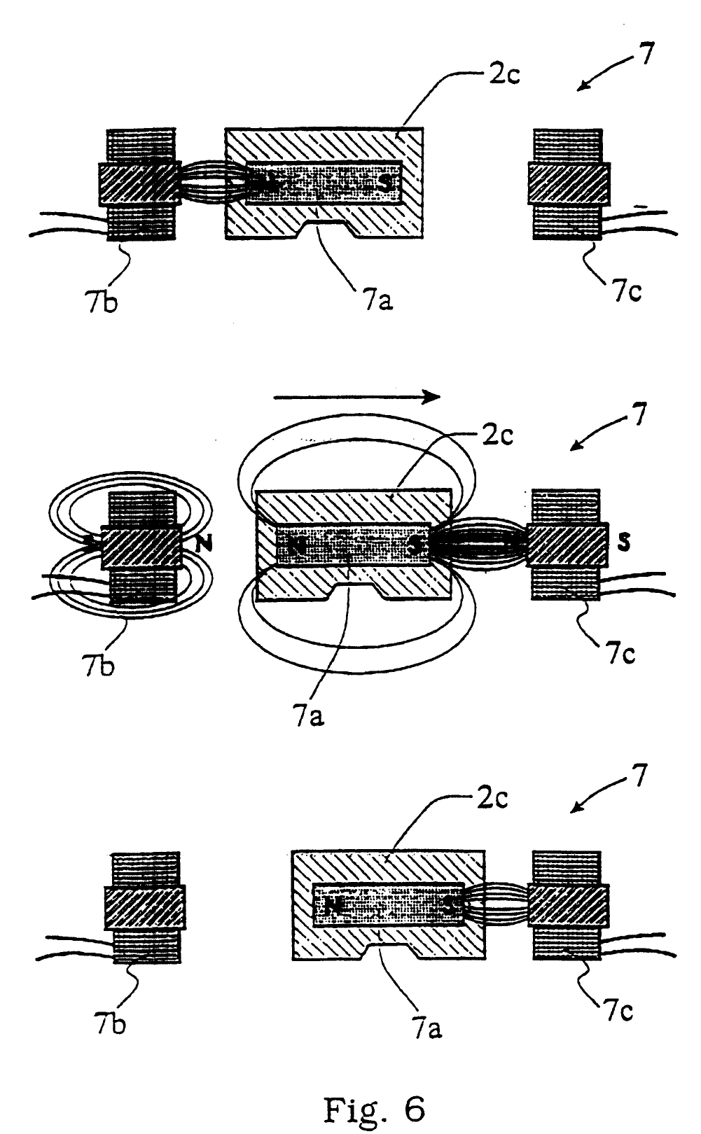

FIG. 6 shows the design of a bistable magnetic actuator, which can be used for the switching of a fiber-optic switching element according to the invention;

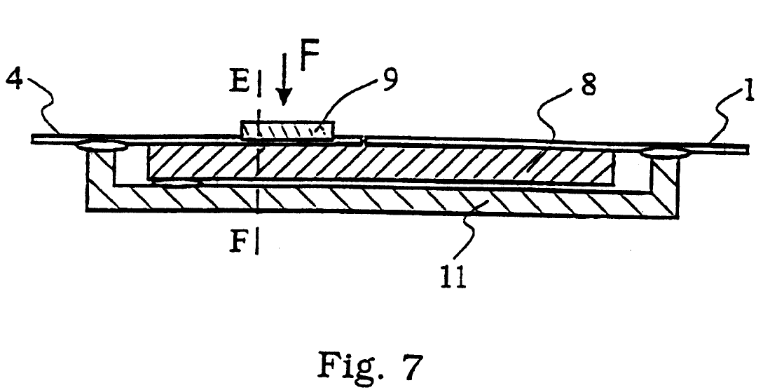

FIG. 7 shows a longitudinal section through a fiber-optic switching element according to the invention, in order to illustrate the axial and lateral attachment of the optical fibers;

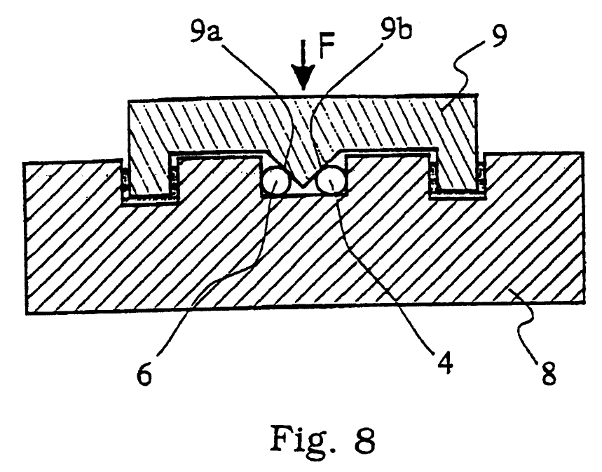

FIG. 8 shows a cross section through a fiber-optic switching element according to the invention, in order to illustrate one advantageous lateral attachment of the optical fibers, which are arranged in fixed positions;

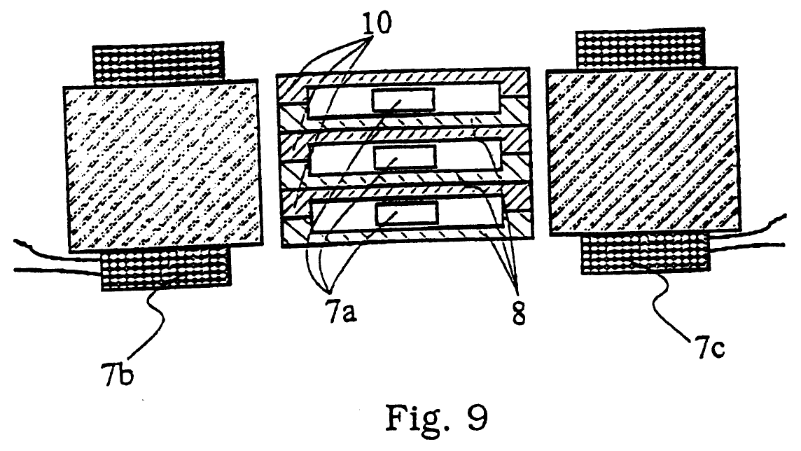

FIG. 9 shows the capability to arrange a number of fiber-optic switching elements according to the invention to form a fiber-optic switch according to the invention;

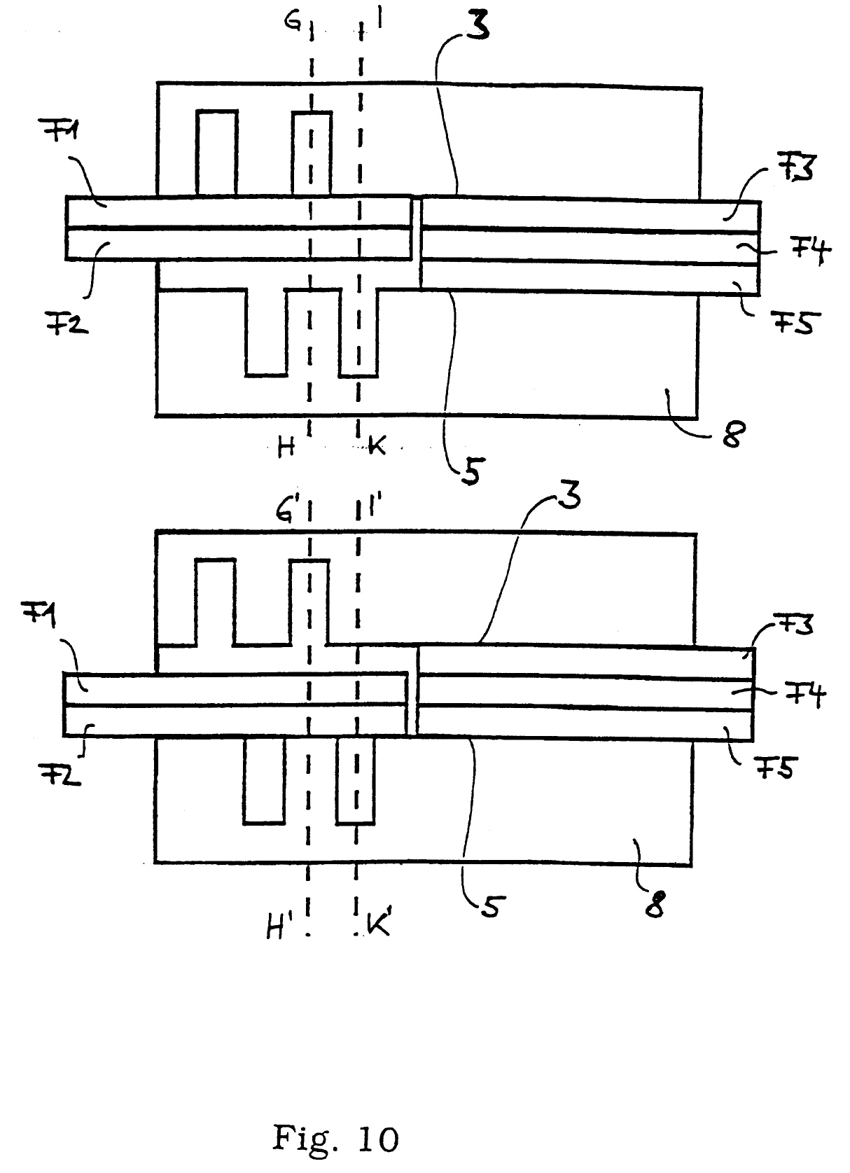

FIG. 10 shows a plan view of a third embodiment of a fiber-optic switching element according to the invention; and

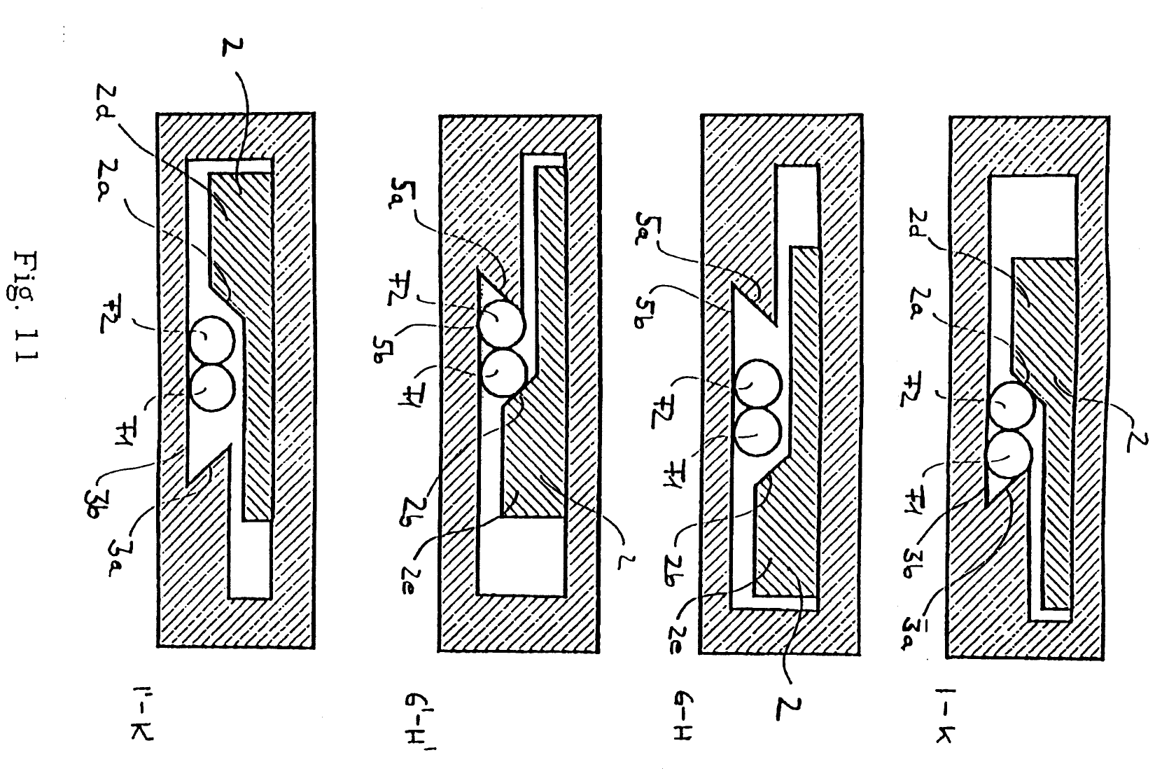

FIG. 11 shows various section illustrations of the third embodiment according to the invention, as illustrated in FIG. 10.

The preferred embodiments of the invention will be described on the basis of the situation in which the signal which originates from a moving input fiber can be switched alternately between two output fibers which are arranged in fixed positions, that is to say the moving input fiber can be selectively positioned in front of one of two output fibers which are arranged in fixed positions. Both the input fiber and the output fibers may be single-mode or multimode fibers. The fiber-optic switching element according to the invention may, of course, also be designed for a signal flow in the opposite direction, in which one of two input signals which are introduced through a respective input fiber which is arranged in a fixed position is passed to a moving output fiber, which can selectively be positioned in front of it.

FIGS. 1a and 1b show a first preferred embodiment of the invention, in which the moving input fiber 1 and the output fibers 4, 6, which are arranged in fixed positions, are located in a common, approximately rectangular groove in a body 8, which is referred to in the following text as a fiber groove, with the input fiber 1 being opposite one of the two output fibers 4, 6, depending on the switching state. The described fixed arrangement of the output fibers relates only to their lateral direction, that is to say to the fact that they rest on respective adjustment surfaces.

Signals are transmitted via an end face coupling, with there being a gap between the fiber end surfaces, which is governed by the axial fixing of the fibers. When using an index matching liquid, the fibers may be in this case cut at right angles or may be inclined at a defined angle. In general, an index matching liquid carries out a number of functions. Firstly, it reduces backward reflections on the fiber end surfaces of the mutually opposite fibers while, secondly, the widening of the beam, which is output from the input fiber 1, in the gap between the input fiber 1 and the corresponding output fiber 4, 6 is reduced. Furthermore, the movement of the fiber in the switch is lubricated by the liquid, thus reducing wear on the materials which in this case rub against one another, and the liquid prevents the fibers from which the sleeves have been removed from becoming brittle as a consequence of the ingress of water. If, on the other hand, no index matching liquid is used, then the back reflection is advantageously reduced by the fiber end surfaces being inclined. However, in this case, due to the increase in the width of the beam in the gap, the injection loss is higher than when using an index matching liquid. In this case, both variants may advantageously be combined with one another, in order to obtain particularly low back-reflection and low optical attenuation.

As an alternative to transmitting signals via a gap located between the fiber end surfaces, it is possible with the fiber-optic switching element according to the invention for the fiber ends also to be coupled, by way of example, by direct contact by means of a spring mechanism, as is disclosed by way of example in WO88/02869, which has already been mentioned above.

The movement of the input fiber 1 from the first switching state in front of the first output fiber 4 which is arranged in a fixed position, to the second switching state in front of the second output fiber 6 which is arranged in a fixed position is carried out electromagnetically, as will be described in more detail in the following text with reference to FIG. 4, and with the two switching states being stable when no power is supplied. The power supply is required only to change the switching state, with a switching body 2, which is not firmly connected to the moving input fiber 1 and has at least one permanent-magnet part, being moved between the two defined positions by means of electromagnetic forces. Alternatively, a monostable arrangement can also be achieved by appropriate choice of the distances between the permanent-magnetic part and the coil core.

The adjustment of the first output fiber 4 and of the moving input fiber 1 in front of the first output fiber 4, which is arranged in a fixed position, is carried out on a first stop 3, and the adjustment of the second output fiber 6, which is arranged in a fixed position, and of the moving input fiber 1 in front of the second output fiber 6, which is arranged in a fixed position, are carried out on a second stop 5. The first stop 3 and the second stop 5 are formed by a respective side wall 3a, 5a as well as the base 3b and 5b of the fiber groove which is provided in the body 8. Since the structure of these surfaces which form the respective stop is kept simple, they can be manufactured with high precision at relatively low cost.

FIG. 1b shows a section illustration of the first embodiment of the invention, as shown in FIG. 1a, along the line AB shown in FIG. 1a, with FIGS. 2a and 2b showing only the functional principle, but not assemblies which are not significant to this purpose, for example the electromagnetic actuator which is shown in FIG. 1a.

FIG. 1b shows the moving input fiber 1, which is located in the fiber groove and rests on the second stop 5, which comprises the side wall 5a and the base region 5b, adjacent to it, of the fiber groove. In the case shown here, the fiber groove has a depth, that is to say a side wall height, which is less than the fiber diameter but is greater than half the fiber diameter. A carriage 2c of the switching body 2 is located such that it rests on the body 8 and has a groove which is aligned with the fiber groove and is referred to in the following text as a switching groove. The carriage 2c can move in the transverse direction into the fiber groove. The switching groove which is located in the carriage 2c has inclined side surfaces 2a, 2b which, in the illustrated case, are at an angle of α=45° to the side walls 3a, 5a and to the base 3b and 5b of the fiber groove which is located in the body 8, such that the switching groove has the cross-sectional shape of a trapezoid in which the open side facing the body 8 is the longer side. The depth of this switching groove which is formed in the carriage 2c is chosen such that the moving input fiber 1 does not abut against its base. The width of the switching groove is chosen such that that part of the moving input fiber 1 which projects from the fiber groove easily finds space therein. The angle α may also be chosen, in contrast to the above situation, such that a contact pressure force is produced on both stop surfaces 3a, 3b and 5a, 5b, with the angle advantageously being between 20° and 70°. Furthermore, side surfaces 2a, 2b may also be chosen having a convex or concave cross section.

A cover 10, which forms a cavity of height h and in which the carriage 2c can move transversely with respect to the fiber groove is placed on the body 8. The carriage 2c has a height D.

As can be seen from FIG. 1b, the moving input fiber 1 is adjusted on the fiber itself and not on the switching body 2, so that greater precision is achieved. The movement of the carriage 2c in the transverse direction with respect to the fiber groove is constrained only by the fact that the moving fiber 1 rests on the first stop 3 or on the second stop 5, and hence also stops the carriage 2c which moves the moving fiber 1 but does not strike against the end walls of the cavity formed by the body 8 and the cover 10. The carriage 2c per se need carry out only an imprecise movement, so that there is no need for precise mechanical guides for the carriage 2c. This acts as a driver, which moves the moving fiber 1 to the respective stop, and presses said fiber 1 against it. Since the side walls 2a, 2b of the switching groove each have a 45° chamfer, as already described, the force is introduced to the moving fiber 1 at 45° to the movement direction, as a result of which the fiber is at the same time pressed against one side wall 3a, 5a and against the base 3b and 5b of the fiber groove, that is to say against the complete adjustment structure. This force also acts when the moving input fiber 1 is in the stop position such that this moving input fiber 1 is adjusted in two dimensions at the same time by the application of the one-dimensional force.

Since the carriage 2c which mechanically moves the moving input fiber 1 is not firmly connected to the input fiber 1, it can be fitted easily. If the carriage —as already stated—only has to exert pressure on the fiber—it requires neither high-precision guidance nor precise external dimensions, but only a respective planar stop surface 2a, +2b. If, as shown in FIG. 2a, the carriage 2c is located in a cavity, then the height of the switching body D may be smaller by an amount between 0 and t than the cavity height h, without influencing the positioning of the moving input fiber 1, whose diameter is 2 r. The maximum tolerance t (=difference between the cavity height h and the switching body height D) is dependent on the height y between the respective side wall 3a or 5a and the fiber groove, on the angle α of the stop surface of the carriage 2c to the side wall of the respective stop 3a or 5a, and on the radius r of the fiber that is used. As is shown in FIG. 1b, this can be calculated in the form t=r(1+sin α)−y. This design variant is feasible only when, for the height y: r≦y≦r(1+sin α).

In one alternative design variant for the first embodiment according to the invention as shown in FIGS. 1a and 1b, the carriage of the switching body does not run on the surface of the body 8 but in a guide groove which is provided in it, is arranged transversely with respect to the fiber groove, and intersects it. In this case, the carriage of the switching body has a switching groove which is formed in accordance with the first design variant as shown in FIGS. 1a and 1b but is deeper so that, in this case, the moving input fiber 1 likewise does not rest on the base of the switching groove.

In this second design variant, the carriage is guided in the guide groove in order to move the fiber against a respective stop 3, 5, and to press it against this stop. This guide groove does not, however, need to be manufactured with high precision, in contrast to the fiber groove, since the carriage is in the form of a driver.

In particular, as also in the first design variant, only one stop surface is in each case required, which is planar and is formed by a respective side wall of the switching groove, although the guide groove should be manufactured with sufficient precision that a force which is applied to the moving input fiber 1 is distributed as far as possible over an entire stop surface. The guide groove should thus allow alignment of the carriage to the extent that its stop surfaces are not at right angles to the movement direction of the carriage, in order that force can be transmitted from the entire stop surface to the moving input fiber 1. A “loose” movement of the carriage which is advantageous for this purpose is promoted, in particular, by the electromagnetic operation which is described in more detail in the following text with reference to FIG. 6. However, other configurations of actuators for the carriage, and which allow the carriage to be aligned within the guide groove, are also possible.

FIGS. 2a and 2b show a second embodiment according to the invention, in which the switching body 2 does not just comprise a carriage 2c with a switching groove which has the cross-sectional shape of a trapezoid, but comprises a carriage 2c with at least two runners 2d, 2e, which are arranged in axially offset positions with respect to the moving fiber 1, are each aligned at right angles to the fiber groove, and each have a planar stop surface 2a, 2b, with the stop surfaces 2a, 2b being inclined in a corresponding manner to one of the stop surfaces 2a, 2b of the carriage 2c in the first embodiment. The runners 2d, 2e may each be configured according to the first or the second design variant of the first embodiment of the invention, that is to say they may either be arranged above the fiber groove that is formed in the body 8, with the fiber groove in this case having a height which is less than the fiber diameter of the moving fiber 1, or may be guided in a respective guide groove, which is arranged in the body 8 transversely with respect to the fiber groove located therein, but not intersecting it, and instead only opening into it on one respective side. The carriage 2c of the switching body 2 according to the second embodiment of the invention is arranged such that it is always located above the moving fiber 1, that is to say it never touches it.

In the illustration shown in FIG. 2a, which shows a section along the line A″B″ shown in FIG. 2b, it can be seen that the moving input fiber 1 is positioned, by means of a second runner 2e, with a stop surface 2b on the second stop 5 in front of the second output fiber 6, which is arranged in a fixed position. Since the second runner 2e is arranged such that it is laterally offset with respect to a first runner 2d, the moving input fiber 1 is not moved to an interruption in the side wall 5a of the second stop 5, pressing against it, but to a continuous stop surface. The moving input fiber 1 can be positioned in front of the first output fiber 4, which is arranged in a fixed position, by means of the first runner 2d, which is arranged laterally offset with respect to the second runner 2e with regard to the moving input fiber 1 and has a first stop surface 2a, with the moving input fiber 1, in this case as well, not being moved with respect to an interruption in the side wall 3a of the first stop 3 and pressing against it, but with respect to a continuous stop surface.

FIG. 2b shows a section illustration of the second embodiment along the line A′B′ shown in FIG. 2a, corresponding to FIG. 1b, for the first embodiment according to the invention. It can be seen that the second stop surface 2b of the second runner 2e presses the moving input fiber 1 against the continuous side wall 5a and the base region 5b of the fiber groove which forms the second stop 5. In a corresponding way, there is no interruption in the side wall 3a of the first stop in the section plane which runs through the first runner 2d.

FIG. 2b shows the first runner 2d with an angle α=45° through which the stop surfaces 2a and 2b are inclined with respect to the side walls 5a and 3a of the fiber groove.

The second embodiment of the invention, which is shown in FIGS. 2a and 2b, is constructed according to the second design variant of the first embodiment of the invention. The second embodiment according to the invention (with laterally offset runners) may, of course, also be constructed according to the invention in accordance with the first design variant, as is shown in FIGS. 1a and 1b, of the first embodiment. The design variant of the second embodiment according to the invention as shown in FIGS. 2a and 2b can also be produced for heights y≧r(1+sin α) in the same way as the second design variant of the first embodiment according to the invention. The guide grooves are in this case located at a height yN above the fiber groove, where y_{N.max}=r. In this case, the tolerance t is calculated to be t=r(1+sin α) −y_{N}. The precision requirements are thus less stringent the smaller y_{N} is, and y_{N} may also be negative.

In the design variant of the second embodiment according to the invention as shown in FIG. 3, the switching body 2 in each case has three runners 2d, 2e, which are arranged on the carriage 2c and act in one direction, that is to say a total of six runners 2d, 2e, of which the three first runners 2d each have a planar first stop surface 2a which corresponds to the first side wall of the carriage 2c in the first embodiment according to the invention, and three second runners 2e each have a planar second stop surface 2b which corresponds to the second side wall of the carriage 2c in the first embodiment according to the invention. The respective stop surfaces 2a, 2b are each aligned such that they are flush with one another, such that they move the moving fiber 1 jointly and press it flat against the respectively corresponding first or second stop.

The left-hand side of FIG. 3 shows a first switching state, in which the moving input fiber 1 is positioned in front of the first output fiber 4, which is arranged in a fixed position, that is to say on the first stop 3. The upper part shows a plan view and the lower part shows a section illustration along the line C′D′ shown in the upper part, with the carriage 2c of the switching body 2, which is indicated by a dashed line in the upper part, not being shown since the aim is to describe only the principle of operation. It can be seen that the moving input fiber 1 is moved to the first side wall 3a and the base 3b of the fiber groove for positioning in front of the first output fiber 4, which is arranged in a fixed position, and is pressed against the first side wall 3a and the base 3b of the fiber groove.

The right-hand side of FIG. 3 shows a second switching state, in which the moving input fiber 1 is arranged in front of the second output fiber 6, which is arranged in a fixed position. In this case, the moving input fiber 1 is moved to the second side wall 5a and the base 5b of the fiber groove and is pressed against them, as is shown in FIG. 2b for the first design variant of the second embodiment according to the invention and in the lower right-hand part of FIG. 3 which, corresponding to the lower left-hand part of FIG. 3, shows a section along the line CD that is shown in the upper part.

The influence of force from the switching body 2 at a number of positions which are offset axially on the moving input fiber 1 results in better fiber adjustment precision, since the moving input fiber 1 is guided not only directly, but even somewhat before the coupling point with a respective output fiber 4, 6, which is arranged in a fixed position, to the respective stop 3, 5, and is pressed against it, thus improving the parallelity of the fiber axis of the moving input fiber 1 and the respective stop 3, 5. Since the position at which the force from the switching body 2 acts on the moving input fiber 1 for the two switching movements to the first or, the second switching state and for the positioning in the two switching states are slightly offset with respect to one another (comb principle), adjustment can be carried out with respect to both stops 3, 5 without the relationships for the moving input fiber 1 differing greatly on both sides.

FIG. 4 shows a perspective view of a body 8 and of a switching body 2 which is matched to it and comprises a carriage 2c in each case having four runners 2d, 2e which act in one direction. On its upper face opposite the runners 2d, 2e, the carriage 2c has a cutout for holding a permanent magnet. Furthermore, FIG. 4 shows a clamping wedge 9, by means of which the output fibers 4, 6, which are arranged in fixed positions, are held firmly laterally in the fiber groove of the body 8, but such that they can be moved axially, as is described in the following text with reference to FIGS. 7 and 8In addition to the fiber groove and the guide grooves for the runners 2d, 2e of the switching body, the body 8 also has two cutouts in which the clamping wedge 9 is adhesively bonded or can be attached in some other suitable way.

FIG. 5 shows a housing for the assemblies of the switching element as shown in FIG. 4, which comprises a housing lower part 11 and a housing cover 12 that matches it, as a three-dimensional illustration. The housing lower part 11 is designed such that it can hold the body 8 and has grooves for fiber guidance, which are aligned with the fiber groove when the body 8 is inserted into the housing lower part 11. Furthermore, the housing lower part 11 has holes for making electrical contact with the electromagnets of the electromechanical actuator 7. The operation of the housing cover 12 normally does not correspond to that of the cover 10 described above, which rests directly on the body 8 and is not shown in FIGS. 4 or 5. However, it is also possible for the housing cover 12 to carry out the function of the cover 10 with adequate precision, which means that the cover 10 may be dispensed with in this case. Further functional features of the housing comprising the housing lower part 11 and the housing cover 12 will be explained in the following text with reference to FIG. 7.

FIG. 6 shows, in three illustrations, the configuration of the bistable magnetic actuator 7 already mentioned above, which is used for switching the switching body 2 according to the invention. By way of example, the bistable magnetic actuator is shown in FIG. 6 with a switching body 2 according to the first embodiment of the invention. The upper illustration shows the magnetic actuator in a second switching state, in which the moving input fiber 1 is arranged on the second stop 5 in front of the second output fiber 6, which is arranged in a fixed position, the central illustration shows a movement of the carriage 2c to the first switching state, in which the moving input fiber 1 is positioned on the first stop in front, of the first output fiber 4, which is arranged in a fixed position, and the lower illustration shows the arrangement of the electromagnetic actuator with the moving carriage 2c in the first switching state. The figures each show only the carriage 2c with the groove provided in it together with the side surfaces 2a and 2b as well as the actuator 7, which comprises the magnets 7a, 7b and 7c and not the body 8 or the fibers 1, 4, 6, since this is a figure which is intended to illustrate the functional principle of the actuator 7.

The electromagnetic actuator 7 comprises two electromagnets 7b, 7c which comprise a coil core on which a coil is wound. The electromagnets 7b, 7c are each arranged in an extension of the movement direction of the carriage 2c, that is to say, for example, aligned with the guide groove according to the second design variant of the first exemplary embodiment of the invention. The coil core is composed of a soft magnetic material, for example of a nickel/iron alloy.

Furthermore, the electromagnetic actuator 7 has a permanent magnet 7a, which is arranged on or in the carriage 2c and whose poles are each aligned with one of the coil cores of the electromagnets 7b, 7c.

The fixing, that is to say the pressing of the moving input fiber 1 in a respective rest position against one of the stops 3, 5, is provided by the interaction of the permanent magnet 7a, which is mounted on the carriage 2c, with the respective coil core of the electromagnet 7b, 7c which is arranged closer to the respective stop. When switching from one switching state to the other, the coils of the two electromagnets 7b, 7c are activated such that that coil by means of whose core the switching body was held in its last rest position now repels this by means of a magnetic field which counteracts the magnetic field of the permanent magnet 7a, while the other coil produces a magnetic field which at the same time attracts the permanent magnet 7a. Once the carriage 2c has reached its new switching position, then the coil current can be switched off and the fixing is once again provided by the magnetic interaction of the permanent magnet, but with the correspondingly other coil core.

This switching principle that has been described previously is illustrated in FIG. 6. The upper illustration of FIG. 6 shows that the switching body 2 is drawn by the north pole of the permanent magnet 7a, which is arranged on or in it, in the direction of the coil core of a first eletromagnet 7b, which then moves the carriage 2c to the second switching stage, and thus produces a force by means of which the carriage 2c presses the moving input fiber 1 against the second stop 5 by means of the stop surface 2b. The central illustration in FIG. 6 shows the process of switching from the first to the second switching state, in that the first electromagnet 7b produces a north pole on its side facing the carriage 2c and repels the permanent magnet 7a, which is arranged on the carriage 2c, and hence the carriage 2c, and a second electromagnet 7c which is arranged closer to the first stop, likewise produces a north pole on its side facing the carriage 2c, as a result of which the south pole of the permanent magnet 7a, which is arranged on the carriage 2c, is attracted. This switching from the second to the first switching state results in the moving input fiber 1 being moved by means of the stop surface 2a away from the second stop 5 toward the first stop 3. Once the carriage 2c has assumed the first switching state, then the coil current in both electromagnets 7b and 7c can be switched off, and the carriage 2c is now held on the first stop 3 only by the magnetic interaction of the permanent magnet 7a with the coil core of the second electromagnet 7c via the moving input fiber, as is shown in the lower illustration in FIG. 6, and as a result of which a force is produced by means of which the carriage 2c presses the moving input fiber 1 against the first stop 3 by means of the stop surface 2a. Alternatively, the switch may also be driven by means of some other actuator, for example by means of a piezo-electric actuator, a thermal actuator, for example a bimetallic actuator or a memory metal actuator.

The functional elements of the switch may advantageously be produced by diecasting (if made of metal), injection molding (if made of plastic) or by other mass-production methods. The simplest processing, whose price is at the same time low, and with the necessary precision, is in this case achieved with plastics. However, in the unreinforced state, these have a severe, temperature-dependent length expansion, which differs from that of the light guide fibers. Reinforced plastics exhibit this effect to a lesser extent, but the required surface qualities cannot be achieved here. If the entire switch is produced from a material which is subject to severe temperature-dependent length expansion, then even a minor temperature change often results in the switch structure contracting or expanding such that the gap between the moving input fiber 1 and the corresponding output fiber 4, 6, which is arranged in a fixed position, is decreased or enlarged, so that the attenuation values which are achieved may vary severely. For normal temperature requirements, attenuation increases may thus occur at high temperatures, and the fiber ends may abut against one another at low temperatures.

This problem can be overcome in design terms by the embodiment shown in FIG. 7, which shows the fibers mounted on a housing lower part 11 rather than being mounted laterally and axially on the switch structure itself, that is to say on the body 8, which housing lower part 11 exhibits less temperature-dependent material expansion and a temperature-dependent material expansion which corresponds to that of the light guide fibers, such as glass or ceramic for glass fiber light conductors or suitable polymers for polymer fibers, to which the body 8 of the switching element is once again attached. This material can likewise be produced very cost-effectively and in large quantities. The lack of precision which can be achieved in this way is, however, sufficient for it to be used as a housing. In FIG. 7, both the moving (within the body 8) input fiber 1 and the output fibers 4, 6, which are arranged in fixed positions (laterally within the body 8), are shown as being fixed firmly on the housing lower part 11 by means of adhesive bonds. Both lateral and axial fixing may be provided here, although axial fixing is essential. The switch structure which is arranged within this housing lower part 11 between the adhesive bonds for the input fiber 1 and the respective output fibers 4, 6 is attached at individual points to the housing lower part 11, for example on the output side by adhesive bonding of the body 8, so that material stresses resulting from different thermal expansions are kept low.

The adhesive bonds of the respective fibers to the housing lower part 11 ensures that the fibers are fixed in the axial direction. In the lateral direction, the output fibers 4, 6 are fixed closely in front of the coupling point by means of a clamping wedge 9 within the fiber groove that is located in the body 8. This clamping wedge 9 is, by way of example, adhesively firmly bonded to the body 8, as is shown in FIG. 8, which illustrates a section along the line EF shown in FIG. 7, with the housing lower part 11 not being shown here, since the aim is to illustrate only the principle of operation of the clamping wedge 9.

FIG. 8 shows that the clamping wedge 9 positions the output fibers 4, 6, which are arranged in (laterally) fixed positions in the body 8, on a respective side wall 3a, 5a and the base 3b and 5b of the fiber groove that is located in the body 8, that is to say on the same stops on which the input fiber is positioned in the corresponding switching position. The force produced by the clamping wedge 9 on the corresponding output fiber 4, 6 produced in a similar way to that produced by the switching body 2 on the moving input fiber 1, but with the force in this case being deflected by means of stop surfaces, which are likewise at an angle of 45° to the surfaces 3a, 3b, 5a, 5b which each form a stop 3, 5, from a direction toward the base of the fiber groove to a direction toward the two surfaces which form the respective stops 3, 5. The clamping wedge 9 is connected to the body 8 in the cutouts, which have already been mentioned in conjunction with FIG. 4 and position it, for example by adhesive bonding. However, instead of adhesive bonding, a detachable connection for example by means of a snap-in technique may also be provided, by way of example.

The clamping wedge 9 clamps the output fibers 4, 6, which are arranged in (laterally) fixed positions, such that they rest firmly against the respective stop 3, 5, but can each be moved axially on it, that is to say in their longitudinal direction.

The axial fixing of the fibers on the housing lower part 11 ensures that the fiber ends of the moving (in the fiber groove of the body 8) input fiber 1 and the output fibers 4, 6, which are arranged in (laterally in the fiber groove of the body 8) fixed positions, are opposite one another, with a small gap.

FIG. 9 shows that a number of switching elements can be placed or stacked alongside one another in order to construct a multiple 1×2 switch, in which case each of the switch bodies 2 can be moved by means of a common actuator 7, which comprises a first electromagnet 7b, a second electromagnet 7c and a number of permanent magnets 7a, corresponding to the number of switching bodies 2 and arranged on them.

Furthermore, a fiber-optic switch component with a number of actuators can also be constructed by means of one or more fiber-optic switches which are stacked one on top of the other or alongside one another.

The fiber-optic switching elements, fiber-optic switches or fiber-optic switch components described in this way according to the invention can thus be produced by producing their individual parts by diecasting, injection molding or similar methods in large quantities at a low price, in which case the assembly process can be automated, since the individual parts need to be adjusted only passively. The required high accuracy for the alignment of the moving fiber in front of the fibers which are arranged in fixed positions is carried out by positioning on common straight walls, and the temperature-dependent longitudinal expansion of the die-cast or injection-molded material is compensated for by the fibers which are arranged in fixed positions being fixed only laterally on this material. The insertion loss and back reflection are reduced by the optional use of an index matching liquid, thus reducing attenuation losses and furthermore lubricating the movement, that is to say the wear on the points which are relevant for positioning is reduced. Furthermore, the moving fiber is protected against becoming brittle. In addition, the fiber end surfaces may also be inclined, in order further to reduce back reflection.

The flat contact pressure of the fiber against a stop which is in each case formed by the fiber groove arranged in the body 8 results in distribution of the force and minimizes any sinking-in of the fiber resulting from elastic deformation of the fiber groove.

The fiber-optic switching elements according to the invention result in a lateral accuracy and angular alignment accuracy in the range of micrometers and milliradians, respectively. For this purpose, at least the first and the second stop are advantageously manufactured using LIGA or laser-LIGA technology.

According to the embodiment described above, the two stops 3, 5 each have two stop surfaces 3a, 5a and 3b, 5b, which are (at least virtually) at right angles to one another. The two stop surfaces may, however, also be at a different angle to one another and/or the stops may have a different number of stop surfaces. Furthermore, the two stops do not need to be designed to be the same, either. In one such case, only one corresponding stop surface 2a, 2b of the switching body 2 need be changed and/or arranged such that the force is distributed uniformly over the moving input fiber 1, such that the latter rests in such a defined position against the respective stop, like the output fibers 4, 6 which are arranged such that they are laterally fixed and make contact there.

Naturally, it is likewise possible for all the exemplary embodiments described above to be combined with one another.

Furthermore, a 1×2 switching element has been described above. The teaching according to the invention may of course also be applied to an n'2 n switching element or an n×m switching element with an appropriate arrangement of the fibers, configuration of the switching body 2, and of the stops. For example, an arrangement according to the second design variant of the first embodiment according to the invention or according to the second embodiment according to the invention is feasible, in which small fiber strips composed of a number of individual fibers which are located alongside one another and are connected to one another rest flat on one side wall of a respective stop, being positioned at right angles through its base or its configuration, for example in the form of a surface matched to the small fiber strip.

FIGS. 10 and 11 show, by way of example, how a 2×3 switching element may be implemented in which, for example, two moving input fibers are positioned in front of three output fibers which are arranged in fixed positions. FIG. 10 shows, schematically, the position of the two moving input fibers F1, F2 and of the three output fibers F3, F4 and F5, which are arranged in fixed positions, in the two switching states. The fiber groove in the body 8 is designed to be straight such that the three output fibers lie alongside one another, abutting against one another, and the two outer fibers each rest on one of the stops 3, 5. In the section illustrations shown in FIG. 11 along the lines GH, IK for the first switching state, and G′H′, I′K′ for the second switching state shown in FIG. 10, it can be seen that the side walls of the fiber groove according to this exemplary embodiment are inclined through approximately 45°, such that the base of the fiber groove is broader than the opening that is opposite it. Furthermore, it can be seen from FIG. 10 that, in this embodiment, a carriage 2c is provided as the switching body 2, and in each case has two runners 2d, 2e, which act in one direction and are offset in the fiber longitudinal direction, since the side walls of the fiber groove have interruptions, which are offset in the fiber longitudinal direction, at the points of the guide grooves, which run at right angles to the fiber groove.

In the first switching state, the second moving input fiber F2 is pressed by the side walls 2a of the first runners 2d against the first moving input fiber F1, which is in turn pressed against the first stop 3 and is positioned on it. Since the side wall 3a of the fiber groove and the stop surface 2a of the runner 2d are inclined, both the moving input fibers are pressed against the base 3b of the fiber groove and are positioned as is shown in the section illustration I-K in FIG. 11. The section illustration G-H shows that the two moving input fibers F1, F2 do not rest on the stop surfaces 2b of the second runners 2e in the first switching state. Since the output fiber F3, which is arranged in a fixed position, likewise rests on the first stop 3 and is positioned with respect to it, and the second output fiber F4, which is arranged in a fixed position, rests on the first output fiber F3, which is arranged in a fixed position, the first moving input fiber F1 is positioned in front of the first output fiber F3, which is arranged in a fixed position, and the second moving input fiber F2 is positioned in front of the second output fiber F4, which is arranged in a fixed position, in the first switching state.

In the second switching state, the second moving input fiber F2 is pressed via the first moving input fiber F1 by the second stop surfaces 2b of the second runners 2e against the second stop 5, as is shown in the section illustration G′-H′, on which the third output fiber F1, which is arranged in a fixed position, likewise rests, and on which in turn the second output fiber F4, which is arranged in a fixed position, once against rests. The section illustration I′-K′ shows that the two moving input fibers F1, F2 do not rest on the stop surfaces 2a of the first runners 2d in the second switching state. Since the second stop 5 and the second stop surfaces 2b of the second runners 2e are inclined in the same way as the first stop 3 and the first stop surfaces 2a of the first runners 2d, both the moving input fibers F1, F2 are pressed against the base 5b of the fiber groove, and are positioned on it. The first moving input fiber F1 is thus positioned in front of the second output fiber F4, which is arranged in a fixed position, and the second moving input fiber F2 is positioned in front of the third output fiber F5, which is arranged in a fixed position, in the second switching state.

The carriage is arranged above the moving input fibers F1, F2, such that they cannot slide one above the other during the movement.

1. A fiber-optic switching element, in which at least one moving fiber (1) is positioned by means of a switching body (2) on a first stop (3) in front of at least one fiber (4), which is arranged in a fixed position, or on a second stop (5) in front of at least one second fiber (6), which is arranged in a fixed position, characterized in that the at least one moving fiber (1) is moved with respect to the first or second stop (3, 5) by the switching body (2) for positioning, and is pressed flat against the first or second stop (3, 5).

2. The fiber-optic switching element as claimed in claim 1, characterized in that the switching body (2) is constrained in its switching movement by the first or the second stop (3, 5) only via the at least one moving fiber (1).

3. The fiber-optic switching element as claimed in claim 1 or 2, characterized in that the at least one first fiber (4), which is arranged in a fixed position, rests on the first stop (3), and the at least one second fiber (6), which is arranged in a fixed position, rests on the second stop (5).

4. The fiber-optic switching element as claimed in one of claims 1 to 3, characterized in that the switching body (2) has a carriage which is not connected to the at least one moving fiber and has at least one first stop surface (2a), by means of which the at least one moving fiber (1) is moved with respect to the first stop (3) and can be pressed against it, and at least one second stop surface (2b) is provided, by means of which the at least one moving fiber (1) is moved with respect to the first stop (5) and can be pressed against it.

5. The fiber-optic switching element as claimed in claim 4, characterized in that one stop surface (2a, 2b) of the switching body (2) is in each case arranged inclined with respect to surfaces (3a, 3b, 5a, 5b) which form a corresponding stop (3, 5), such that the at least one moving fiber (1), which is pressed against the corresponding stop (3, 5) by the switching movement of the respective stop surface (2a, 2b) of the switching body, rests against the surfaces (3a, 3b, 5a, 5b) which form the stop (3,5).

6. The fiber-optic switching element as claimed in one of claims 1 to 5, characterized in that the first and the second stop (3, 5) are each formed by a side wall (3a, 5a) and the base (3b, 5b) of a groove, against which side wall (3a, 5a) and base (3b, 5b), respectively, the at least one first and the at least one second fiber (4, 6), which are arranged in a fixed position, rest.

7. The fiber-optic switching element as claimed in claim 6, characterized in that the respective side walls (3a, 5a), which also form the respective first and second stop (3, 5), are, at least in the region of the stop surface (2a, 2b) of the switching body for a moving fiber (1), at a level which is less than the fiber diameter of the one moving fiber (1).

8. The fiber-optic switching element as claimed in claim 6 or 7, characterized in that the respective side walls (3a, 5a) which also form the respective first and second stop (3, 5) have, in the region of the switching body (2), at least one interruption, in each of which a part of the switching body (2) runs which acts on the at least one moving fiber (1).

9. The fiber-optic switching element as claimed in claim 8, characterized in that the interruptions in the opposite side walls (3a, 5a) are offset with respect to one another.

10. The fiber-optic switching element as claimed in one of claims 1 to 9, characterized in that the switching body (2) is driven by a bistable or monostable magnetic actuator (7).

11. The fiber-optic switching element as claimed in one of claims 1 to 10, characterized in that the switching body (2) and/or the body (8) which has the first and the second stop (3, 5) are produced by molding.

12. A fiber-optic switch characterized by one or more fiber-optic switching elements which are stacked one on top of the other, as claimed in one of claims 1 to 11, whose switching bodies (2) are driven jointly by a common actuator (7).

13. A fiber-optic switch component, characterized by one or more fiber-optic switches which are stacked one on top of the other, as claimed in claim 12.
